(19) United States
(12) Patent Application Publication
(10) Pub. No.: US 2006/0036954 A1
(43) Pub. Date: Feb. 16, 2006

(54) Web services based portlet catalog

(75) Inventors: Antony Satyadas, Lexington, MA (US); Birendro Roy, Baton Rouge, LA (US); Amar P. Patel, Homestead, FL (US); Berkley R. Egenes JR., Cambridge, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/881,841

(22) Filed: Jun. 30, 2004

Related U.S. Application Data
(63) Continuation-in-part of application No. 10/852,790, filed on May 25, 2004.

(51) Int. Cl. G06F 17/00

(52) U.S. Cl. 715/742

(57) ABSTRACT

Described is a method for determining a portlet for inclusion in a portal for an industry specific business role. The portlet provides access to a web based capability associated with the business role. Industry specific information associated with the business role is mapped to the desired web based capabilities to generate metadata. An internal portlet catalog and an external portlet catalog accessible over a network are searched to identify portlets matched to the metadata. The portlets in the portlet catalogs can be arranged according to categories to facilitate searching. One of the identified portlets is selected according to a selection algorithm. The selection algorithm can be based on a historical ranking of the identified portlets. If no portlets are identified from the search, a new portlet developed to provide the desired web based capability can be published in the external catalog to allow third party use.

### RELATED APPLICATION

This application is a continuation-in-part application claiming priority to co-pending U.S. patent application Ser. No. 10/852,790, filed May 25, 2004, titled “Portal Generation for Industry Specific Business Roles.”

### FIELD OF THE INVENTION

The invention relates generally to a method for determining a portlet to be included in a portal for a business role. In particular, the invention relates to a method for determining the portlet based on a search of an internal portlet catalog and an external portlet catalog accessible through a network.

### BACKGROUND

As use of computer networks and the Internet continues to expand, so to has the interest in portals. A portal is a web based application that provides a single personalized point of access for presentation of information and resources to a user or a group of users. A common portal is the web page presented to a user when first accessing the Internet or a computer network. Web content received from various content providers is aggregated and displayed in the portal web pages. The content can include static information and dynamic data streams. The portal can include various personalization features to provide customized content to the user. In some instances, the portal is configured as multiple pages having linked capabilities. Advantageously, portals reduce the need to learn a new interface for each web based application or resource accessed by a user and can simplify the interaction of the user with frequently referenced information sources.

Portals enable the display of web components, or “portlets”, for self-contained applications or content. Portlets generally are developed according to standards that allow the portlets to be “plugged into” any portal supporting the standards. By way of example, portlets can include e-mail, search engines, news sites, online shopping, chat sites, discussion forums and various other information sources including weather sites, map sites, stock quote sources, and various applications from commercial off the shelf (COTS) to homegrown, legacy and new applications.

Portals can be used in a business environment to provide users with a common set of resources and data. For example, a business may have numerous employees performing similar job functions and having a need to access similar business-related information sources. Thus it is beneficial to provide a similar portal for each employee engaged in a common business role. Software developers, however, must expend significant time and effort researching business roles and processes to develop products for enterprise software customers. In particular, development of a new portal with an appropriate set of portlets is generally necessary to satisfy the customer's requirements for a particular industry role. Moreover, a new interface is learned for each application or resource accessed by an end user.

The selection of the portlets for a portal represents an important part of the portal development effort. Portlets may be readily available, for example, if they were previously generated and locally stored in an internal portlet catalog or otherwise made locally accessible with the development tool. However, if an appropriate portlet is not available in the internal portlet catalog, a portlet has to be generated to satisfy the desired capability. Moreover, any generated portlets are only available to the particular development instantiation.

What is needed is a means to provide a developer with an expanded set of portlets to satisfy the capability requirements of the portal. The present invention satisfies this need and provides additional advantages.

### SUMMARY OF THE INVENTION

In one aspect, the invention features a method for determining a portlet to be included in a portal for a business role. The portlet provides access to a web based capability associated with the business role. Industry specific data associated with the business role is mapped to the web based capabilities to generate metadata. An internal portlet catalog and an external portlet catalog are searched to identify at least one portlet matched to the metadata. A portlet to be included in the portal for the business role is determined from the at least one portlet identified by the searching of the internal and external portlet catalogs.

In another aspect, the invention features a computer program product for determining a portlet to be included in a portal for a business role. The portlet provides access to a web based capability associated with the business role. The computer program product includes a computer useable medium having embodied therein program code for mapping industry specific information associated with the business role to the web based capabilities to generate metadata, program code for searching an internal portlet catalog to identify at least one portlet matched to the metadata, program code for searching an external portlet catalog to identify at least one portlet matched to the metadata and program code for determining the portlet to be included in the portal for the business role. The determination is made from the at least one portlet identified by the searching of the internal and external portlet catalogs.

In still another aspect, the invention features a computer data signal embodied in a carrier wave for determining a portlet to be included in a portal for a business role. The portlet provides access to a web based capability associated with the business role. The computer data signal includes a computer useable medium having embodied therein program code for mapping industry specific information associated with the business role to the web based capabilities to generate metadata, program code for searching an internal portlet catalog to identify at least one portlet matched to the metadata, program code for searching an external portlet catalog to identify at least one portlet matched to the metadata and program code for determining the portlet to be included in the portal for the business role. The determination is made from the at least one portlet identified by the searching of the internal and external portlet catalogs.

In yet another aspect, the invention features an apparatus for determining a portlet to be included in a portal for a business role. The portlet provides access to a web based capability associated with the business role. The apparatus includes means for mapping industry specific information associated with the business role to the web based capabilities to generate metadata, means for searching an internal portlet catalog to identify at least one portlet matched to the metadata, means for searching an external portlet catalog to identify at least one portlet matched to the metadata and means for determining, from the at least one portlet identified by the searching of the internal and external portlet catalogs, the portlet to be included in the portal for the business role.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a networked computer environment having a portal server and distributed users.

FIG. 2 depicts a portal for user access to web based information and resources.

FIG. 3 is a block diagram illustrating the perspectives of software developers with respect to the presentation, application and data tiers associated with an embodiment of a method for generating a portal for an industry specific business role according to the invention.

FIG. 4 is a block diagram illustrating the perspective of end users with respect to the presentation, application and data tiers associated with an embodiment of a method for generating a portal for an industry specific business role according to the invention.

FIG. 5 is a block diagram illustrating the interaction of software components associated with an embodiment of a method for generating a portal for an industry specific business role according to the invention.

FIG. 6 is a flowchart representation of an embodiment of a method for generating a portal for an industry specific business role according to the invention.

FIG. 7 is a flowchart representation of an embodiment of a method for determining a portlet to be included in a portal for a business role according to the invention.

### DETAILED DESCRIPTION

In brief overview the present invention relates to a method for determining a portlet to be included in a portal for a business role. The portlet allows a user to access a web based capability associated with the business role. Industry specific information related to the business role is determined and mapped to web based resources to generate metadata. Advanced text mining algorithms and ontologies can be used for semi-automatic generation of the metadata. An internal portlet catalog and an external portlet catalog accessible through a network are searched to find portlets matched to the metadata. One of the identified portlets is selected for inclusion in the portal for the business role. If no portlet is identified from the searches, the portlet is generated. Optionally, the generated portlet is replicated in the external portlet catalog, allowing other developers to retrieve the generated portlet from the external portlet catalog. The accumulation of portlets in the external catalog represents a significant asset to all developers who otherwise might use portlets that are not efficiently matched to the required capability or may otherwise require independent development of portlets for similar web based capabilities.

The searching of external portlet catalogs enables existing portlets to be provided to a larger development population. Furthermore, the extensible architecture permits smarter algorithms to be implemented for searching and selecting from the identified portlets.

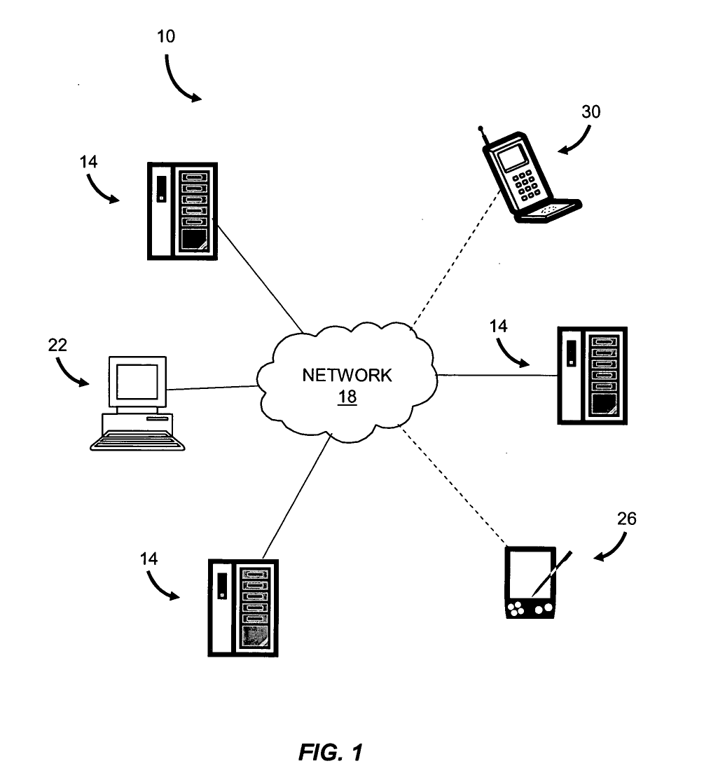

Referring to FIG. 1, a networked environment 10 in which software products generated according to the method of the invention may be used is depicted. The networked environment 10 includes servers 14 in communication with clients over a network 18. As illustrated, the clients include a personal computer (PC) 22, a personal digital assistant (PDA) 26 and a web enabled cell phone 30. Other devices capable of data communications with the servers 14 are also contemplated. The network 18 can be an intranet, the Internet or any network or combination of networks that supports the transmission of data between the server 14 and the clients. Each client includes a user interface for the presentation of text, images and graphics to a user.

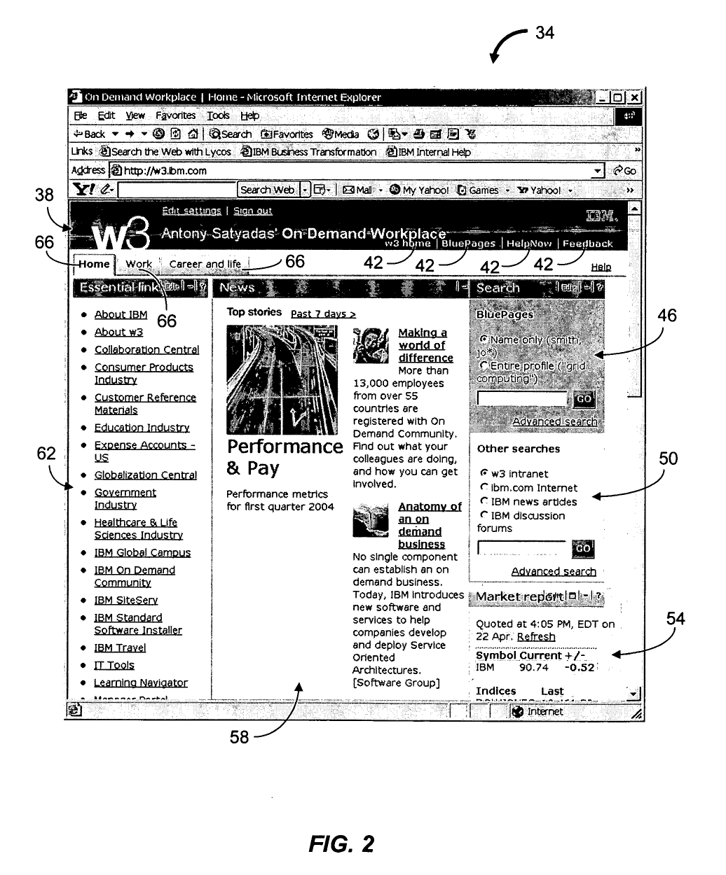

At the beginning of a user session, a user is provided with a portal page appropriate to the user's business role. FIG. 2 depicts an example of a portal page 34 customized according to the preferences of a user. The portal 34 includes banner section 38 that remains static during a user's session. The banner section 38 identifies the user and the user's employer, and includes tabs 42 to allow quick access to predefined functions (e.g., help and feedback) available through employer resources. The illustrated portal page 34 is the user's “home page” and includes a portlet 46 that provides a specific searching capability, a portlet 50 allowing the user to select other searches, and a stock quote portlet 54 providing stock market data. Another portlet 58 displays brief summaries of current “top stories” and includes hyperlinks allowing the user to display a story in its entirety. Another portlet 62 provides a list of “essential links” and includes vertically displayed links to various resources available from the employer and third parties. The portlets 46, 50, 54, 58 and 62 are arranged (i.e., positioned) according to a page layout associated with the home portal page 34. The home portal page 34 includes tabs 46 to provide access to other portal pages. Other portal pages typically provide portlets that are different than those of the home portal page 34, although one or more portlets can be similar or identical to portlets in the home page 34. In addition, the layout of other portal pages typically differs from the layout of the home page 34.

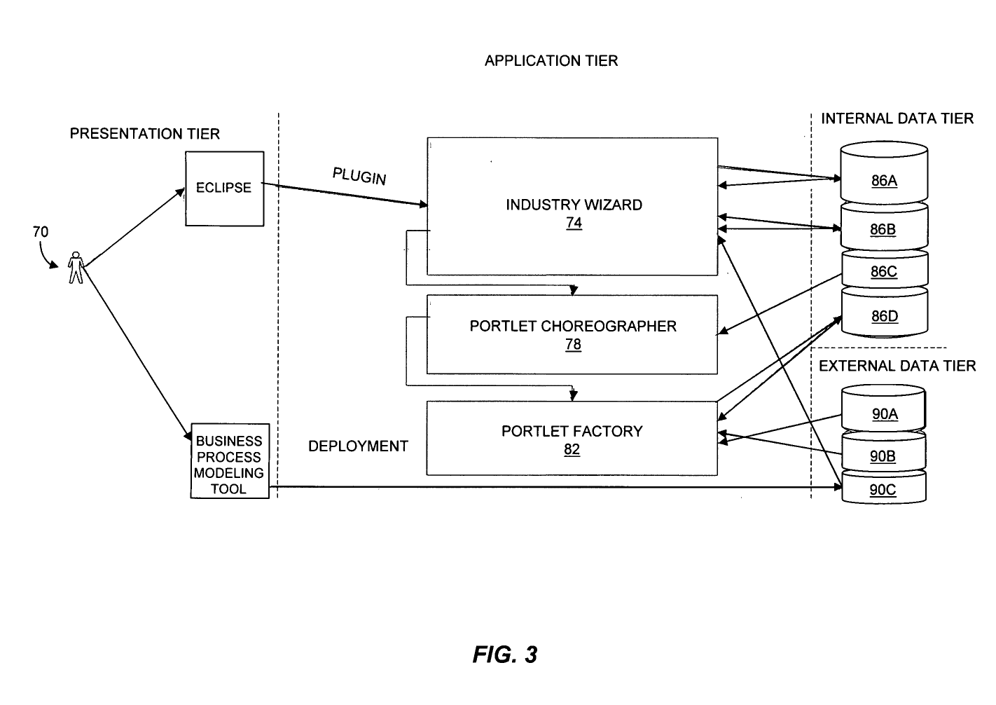

FIG. 3 illustrates a functional overview of an embodiment of a portal generation architecture from the software developer's perspective according to the invention. Software developers, business partners, business consultants, and systems integrators (generally developers 70) assist in the creation of plugins generated according to an Eclipse development environment although, in other embodiments, other development environments can be used. In the illustrated embodiment, an industry wizard 74, a portlet choreographer 78 and a portlet factory 82 are provided and interact with each other to produce a portal for a specific business role as described in more detail below.

Internal data resources 86 are utilized (by performing read from and/or write to operations) during the process and include data storage allocated for industry business role task mappings 86A, task to capability mappings 86B and page templates (i.e., defined page layouts) 86C. A searchable internal portlet catalog 86D is a source of portlets that can be accessed during the generation of the portal. As depicted, the internal portlet catalog 86D is a single catalog, however, in other embodiments, multiple internal portlet catalogs can be provided. For example, a Websphere Portal catalog can be used in addition to the illustrated internal portlet catalog 86D. Generally, portlets packaged in the Websphere Portal catalog are available to any developers having access to a common portal factory (e.g., Websphere Portal Factory). In contrast, the internal portlet catalog 86D allow a developer to keep at least some of the portlets private.

External data resources 90 and capabilities utilized during the process include a Websphere Application Portlet Integrator (WPAI) 90A, an external business portlet catalog 90B and a business process model 90C. The WPAI 90A is a portlet builder that allows users to create and manipulate data in various applications. In other embodiments, WPAI 90A is replaced with other available software tools for rapid portlet development. The external portlet catalog 90B is a remote source of portlets that is accessed during the process to generate the desired portal. Generally, the external portlet catalog 90B allows developers to publish portlets so that they are available for use by other developers. To permit efficient access to portlets, various web services technologies can be implemented, such as SOAP (simple object access protocol), (WSDL) web services description language and UDDI (universal description, discovery and integration). Thus, the portlet can be deployed once and used from many locations. The business process model 90C is a remote resource that can be implemented by the industry wizard 74 when performing industry business role mapping.

The internal and external portlet catalogs 86D, 90B preferably maintain portlets according to categories and sub-categories. Thus, searching of the portlet catalogs 86D, 90B can be performed, for example, by implementing a metadata keyword search (e.g., name search or description search) that can be applied to a particular category or all categories. Optionally, the portlet catalogs 86D, 90B include historical ranking data for each portlet. The ranking data is based on the number of times each portlet has been deployed. The selection of a portlet from those identified in the search can be based on the portlet having the highest ranking. Other selection techniques can be based on fuzzy clustering and other goodness of fit computational intelligence based algorithms. Multi-criteria group decision support algorithms can be used to capture subject matter expert preferences and consensus. Supporting ontologies can drive industry domain and role specific bias.

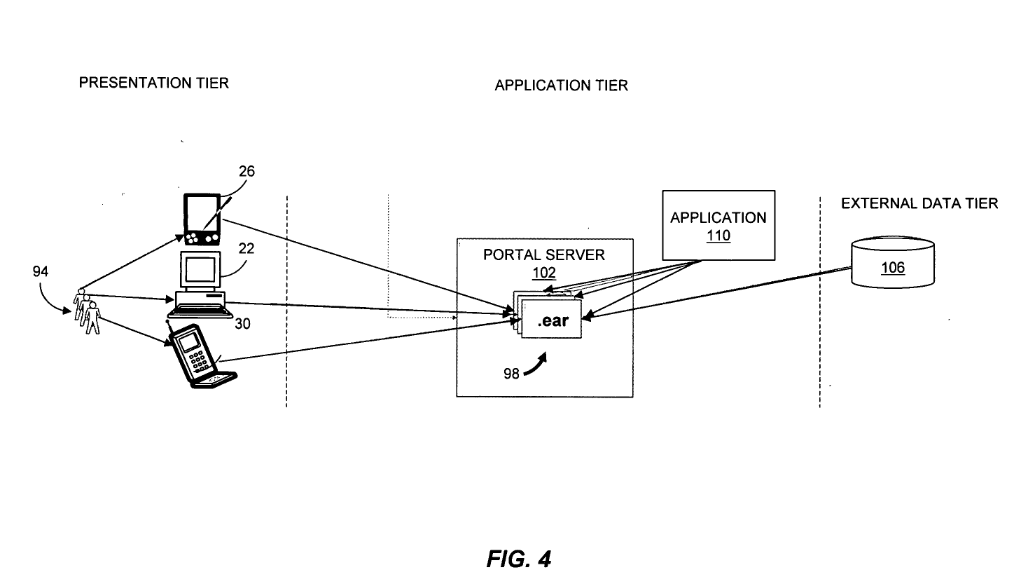

FIG. 4 illustrates an end user's interaction with a portal 98. The end user 90 accesses the portal 98 from a portal server 102 having an associated database 106 using any of a variety of clients (e.g., a PC 22, a PDA 26 or a cell phone 30). The user executes an application 110 to provide the portal 98 with the appropriate portlets. The application 110 can reside on the client 22, 26 or 30, the portal server 102 or another server (not shown). The portal 98 developed according to the process enabled by the architecture illustrated in FIG. 3 is packaged, for example, as an ear file (i.e., Java enterprise application packaging unit).

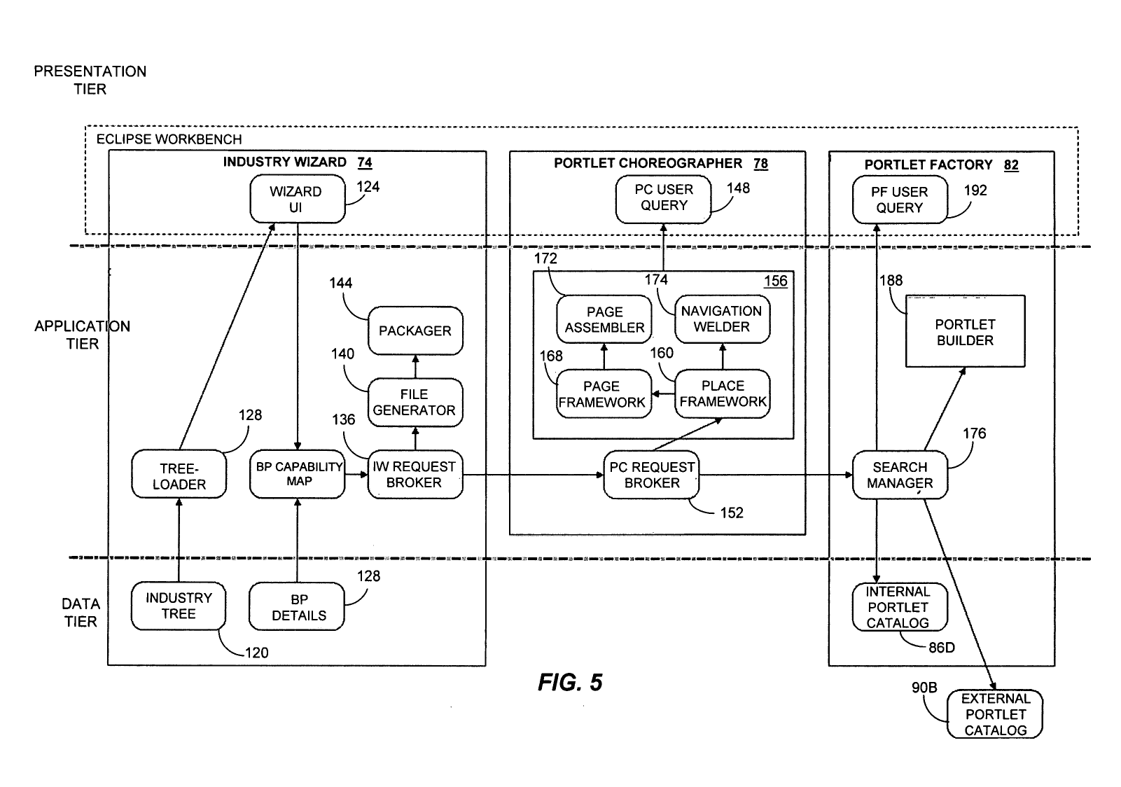

FIG. 5 is a block diagram illustrating the interaction of various software components for the industry wizard 74, the portlet choreographer 78 and the portlet factory 82 (see FIG. 3). The industry wizard 74 includes an industry tree 120 (e.g., an XML formal tile) providing valid industries, roles and business processes to a wizard user interface (UI) 124 when loaded by a treeloader component 128. A developer can select the desired elements from each industry, role and business process category. The developer selections and stored business process data 128 are provided to a capability mapper component 132. Business process data includes encapsulated details of all stored business processes, including component activities and tasks, and the capabilities associated with these tasks. The capability mapper 132 generates a sequence of sets of capabilities that represent elements of the identified business process. As used herein, a capability is a unit of functionality used in completing a portion of the business process. Generally, a capability represents functionality that can be provided by a single portlet. Capabilities can occur in series, in parallel or as a combination of series and parallel occurrences. A request broker 136 receives the sequence of sets of capabilities and arranged portlets provided by the portlet choreographer 78. A file generator 140 generates a basic site hierarchy based on the capability sets and the arranged portlets. The basic site hierarchy defines the “places” (set of page layouts that address the business processes associated with the business role) for each role and can provide default home pages. A packager component 144 generates a deployable archive (e.g., an .ear file) based on the portlets and any supporting files as defined in the basic site hierarchy.

The portlet choreographer 78 includes a request broker 152 which provides a single communication point to the industry wizard 74 and the portlet factory 82. The request broker receives the selected industry, role, business process and capability sets and generates a portal tree (i.e., a portal hierarchical structure) associated with the capability sets. The portal tree includes a place set, a page set, and “wiring” between portlets within a portal page and across multiple portal pages. A wired portlet refers to a portlet that communicates with at least one other portlet. Wired portlets can be on the same portal page or distributed across multiple portal pages. The wiring of portlets permits a determination of which portlets are displayed in the present portal page during a given point in the execution of a business process.

The portlet choreographer 78 also includes a user query component 148 that permits the developer to specify or change portions of the portal tree such as the placement of portlets within a page and the creation of places. Thus, a user query component 148 takes an existing data structure representing the portal tree and generates a modified portal tree structure according to developer's requested changes. In one embodiment, the user query 148 utilizes a graphical user interface to manipulate sections of the portal tree according to a drag and drop method. The modified portal tree structure can be an XML file updated according to the changes made by the developer.

The portlet choreographer 78 also includes a page factory module 156 that provides components having a range of functionalities. A place framework component 160 calls the user query component 148 to allow the developer to automatically or manually select the places for roles in the portal tree, and generates a set (or framework) of places. Automatic selection is based upon portal development history. Once all the places are created, the place framework component 160 creates a place shortcut/menu bar and calls the user query module 148 to modify or confirm the place shortcut/menu bar. Similarly, the page framework component 164 calls the user query component 148 to permit the developer to automatically or manually select page layouts, and generates a set of portal pages. Once all the pages are assembled, the page framework component 164 creates a page shortcut/menu bar and calls the user query module 148 to modify or confirm the page shortcut/menu bar. The page framework component 164 calls a page assembler component 172 which allows the developer to select portlets automatically or manually. The page assembler component 172 gathers the information associated with a page, including the specific portlets for the page, the initial layout of the portlets in the page and the wiring between the portlets. The developer can also interact with the page assembler component 172 to confirm the layout of the portlets on a page. A navigation welder component 174 “wires” the pages of a portal to enable portlets in one page to communicate in the desired way with portlets in other pages.

The portlet factory 82 includes a search manager component 176 that receives a capability request from the portlet choreographer 78 and coordinates the search for an appropriate portlet from one or more internal portlet catalogs 86D and external portlet catalogs 90B (also see FIG. 3). If no appropriate portlet is found, the search manager 176 accesses a portlet builder component 188 to generate a portlet for the required capability. Internal portlet catalogs 86D store portlets that have previously been used and which may have been accessed from an external source or generated in a previous implementation of the method. External portlet catalogs 90B store portlets made available by multiple users through independent data systems and can be used to implement a required capability. Although external portlet catalogs 90B may be available in formats not directly compatible with the format of internal portlet catalogs 86D, a catalog interface can be specified so that the external portlet catalogs 90B are accessed using an appropriate adapter. The portlet builder component 188 generates a portlet which implements a required capability when no existing portlet can be found. In one example, the portlet builder 188 is a component that encapsulates the functionality of WPAI or a similar application portlet builder. Finally, the portlet factory 82 includes a user query component 192 that asks the developer to specify a locally-stored portlet to implement a particular capability when no corresponding portlet is found in the portlet catalogs 86D, 90B and cannot be provided by the portlet builder 188.

It should be recognized that the above description of an embodiment of software components for the industry wizard 74, portlet choreographer 78 and portlet factory 82 are not limiting. Other combinations of software components providing similar functionality are also contemplated according to the invention.

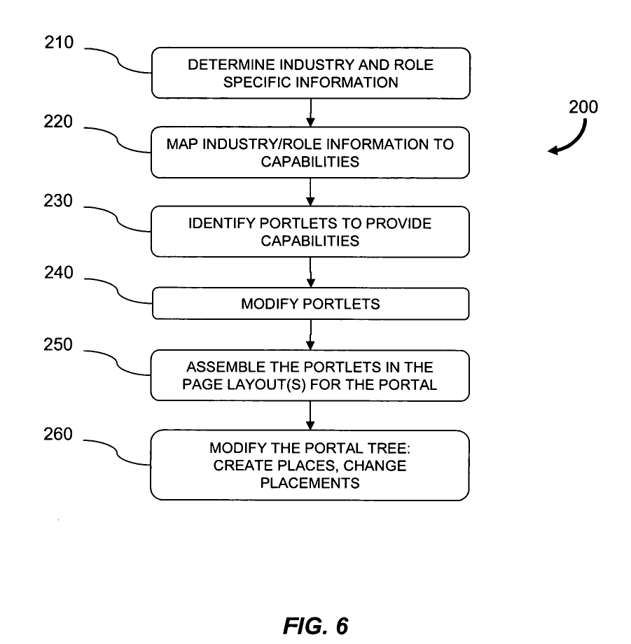

FIG. 6 illustrates an embodiment of a method 200 for generating a portal for a business role which can be implemented using the component architecture described above. The method 200 includes determining (step 210) industry specific information associated with the business role. The industry specific information is mapped (step 220) to a plurality of capabilities associated with the business role. Portlets which provide the capabilities are then identified (step 230). The developer can modify (step 240) the portlets via the portlet factory user query. For example, a developer may choose to select a local portlet if no appropriate portlet is found in the portlet catalogs or is generated by the portlet builder. The portlets are assembled (step 250) in one or more page layouts for the portal. Assembly can include the wiring of two or more portlets to achieve a desired dependence between the associated business process capabilities. The developer has the option of modifying (step 260) the portal hierarchy, for example, by creating new places and changing the placements in the page layouts.

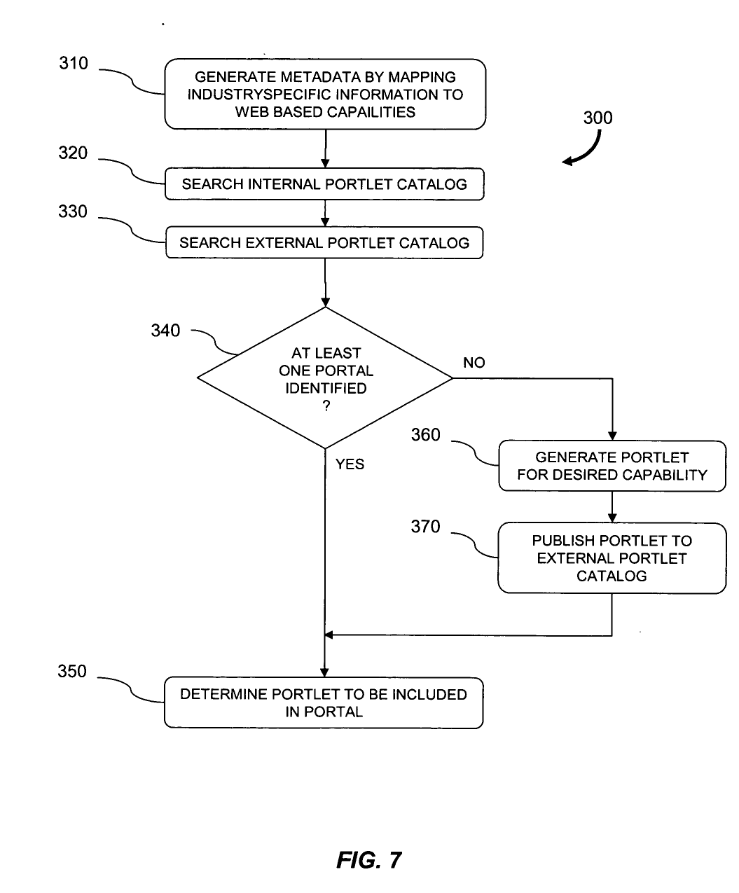

FIG. 7 illustrates an embodiment of a method 300 for determining a portlet to be included in a portal for a business role. The method 300 includes mapping (step 310) industry specific information associated with the business role to desired web based capabilities to generate metadata. An internal portlet catalog is searched (step 320) to identify portlets matched to the metadata. Similarly, an external portlet catalog is searched (step 330) to identify candidate portlets. If one or more portlets are identified (step 340) from the searches, a single portlet is selected (step 350) for inclusion in the portal to provide the web based capability. However, if no portlets are found in the searches, a portlet is generated (step 360) to provide the desired capability and the generated portlet is written (i.e., published) (step 370) to the external portlet catalog to allow access by other developers.

While the invention has been shown and described with reference to specific embodiments, it should be understood by those skilled in the art that various changes in form and detail may be made therein without departing from the spirit and scope of the invention.

What is claimed is:

1. A method for determining a portlet to be included in a portal for a business role, the portlet providing access to a web based capability associated with the business role, the method comprising:
mapping industry specific information associated with the business role to the web based capabilities to generate metadata;
searching an internal portlet catalog to identify at least one portlet matched to the metadata;
searching an external portlet catalog to identify at least one portlet matched to the metadata;
determining, from the at least one portlet identified by the searching of the internal and external portlet catalogs, the portlet to be included in the portal for the business role.

2. The method of claim 1 further comprising:
generating the portlet to be included in the portal if at least one portlet is not identified by searching the internal portlet catalog and the external portlet catalog.

3. The method of claim 2 further comprising publishing the generated portlet to the external catalog.

4. The method of claim 1 wherein the external portlet catalog stores a plurality of portlets accessible by a standardized web services protocol.

5. The method of claim 1 wherein the internal portlet catalog and the external portlet catalog are each partitioned into categories adapted for independent searching.

6. The method of claim 1 wherein the determination of the portlet to be included in the portal is based on a historical ranking of a plurality of identified portlets.

7. A computer program product for determining a portlet to be included in a portal for a business role, the portlet providing access to a web based capability associated with the business role, the computer program product comprising a computer useable medium having embodied therein program code comprising:
program code for mapping industry specific information associated with the business role to the web based capabilities to generate metadata;
program code for searching an internal portlet catalog to identify at least one portlet matched to the metadata;
program code for searching an external portlet catalog to identify at least one portlet matched to the metadata; and
program code for determining, from the at least one portlet identified by the searching of the internal and external portlet catalogs, the portlet to be included in the portal for the business role.

8. The computer program product of claim 7 further comprising program code for generating the portlet to be included in the portal if at least one portlet is not identified by searching the internal portlet catalog and the external portlet catalog.

9. The computer program product of claim 8 further comprising program code for publishing the generated portlet to the external catalog.

10. A computer data signal embodied in a carrier wave for determining a portlet to be included in a portal for a business role, the portlet providing access to a web based capability associated with the business role, the computer data signal comprising:
program code for mapping industry specific information associated with the business role to the web based capabilities to generate metadata;
program code for searching an internal portlet catalog to identify at least one portlet matched to the metadata;
program code for searching an external portlet catalog to identify at least one portlet matched to the metadata; and
program code for determining, from the at least one portlet identified by the searching of the internal and external portlet catalogs, the portlet to be included in the portal for the business role.

11. The computer data signal of claim 10 further comprising program code for generating the portlet to be included in the portal if at least one portlet is not identified by searching the internal portlet catalog and the external portlet catalog.

12. The computer data signal of claim 11 further comprising program code for publishing the generated portlet to the external catalog.

13. An apparatus for determining a portlet to be included in a portal for a business role, the portlet providing access to a web based capability associated with the business role, the apparatus comprising:
means for mapping industry specific information associated with the business role to the web based capabilities to generate metadata;
means for searching an internal portlet catalog to identify at least one portlet matched to the metadata;
means for searching an external portlet catalog to identify at least one portlet matched to the metadata; and
means for determining, from the at least one portlet identified by the searching of the internal and external portlet catalogs, the portlet to be included in the portal for the business role.

14. The apparatus of claim 13 further comprising means for generating the portlet to be included in the portal if at least one portlet is not identified by searching the internal portlet catalog and the external portlet catalog.

15. The apparatus of claim 14 further comprising means for publishing the generated portlet to the external catalog.

16. The apparatus of claim 13 wherein the external portlet catalog stores a plurality of portlets accessible by a standardized web services protocol.

17. The apparatus of claim 13 wherein the internal portlet catalog and the external portlet catalog are each partitioned into categories adapted for independent searching.

18. The apparatus of claim 13 wherein the determination of the portlet to be included in the portal is based on a historical ranking of a plurality of identified portlets.
